(19) United States
(12) Patent Application Publication
(10) Pub. No.: US 2020/0273057 A1
(43) Pub. Date: Aug. 27, 2020

(54) Calculus for Collaborative Online Commerce

(71) Applicant: International Business Machines Corporation, Armonk, NY (US)

(72) Inventors: Sreekrishnan Venkateswaran, Bengaluru (IN); Srikrishna Paparaju, Bengaluru (IN); Ashoka S. Rao, Bengaluru (IN); Shiva P. Chandrashekar, Bengaluru (IN)

(21) Appl. No.: 16/284,060

(22) Filed: Feb. 25, 2019

(51) Int. Cl. G06Q 30/02; G06Q 30/06

(52) U.S. Cl. CPC G06Q 30/0223; G06Q 30/0222; G06Q 30/0605; G06Q 30/0211

(57) ABSTRACT

Calculus for collaborative online commerce is provided. An input is received to generate a group of online shopping members based on product category of online shopping. Product purchasing affinity quotients of members in a member group corresponding to the product category of online shopping are retrieved from a member group database. A set of members is selected in the member group having a product purchasing affinity quotient above a defined affinity quotient threshold level corresponding to the product category of online shopping. The group of online shopping members is generated based on the set of members in the member group having product purchasing affinity quotients above the defined affinity quotient threshold level corresponding to the product category of online shopping.

### BACKGROUND

### 1. Field

The disclosure relates generally to online commerce and more specifically to providing a calculus for collaborative online commerce.

### 2. Description of the Related Art

Online shopping is a form of electronic commerce that allows consumers to directly buy products, which may include for example, goods or services, from a product provider or seller over the Internet using a web browser. Online shopping customers find a product of interest by visiting a web site of the product provider directly or by visiting an online shopping broker that displays availability and pricing of the same product for multiple product providers. Customers are able to shop online using a wide-range of different devices, such as desktop or personal computers, laptop computers, tablet computers, smart phones, smart televisions, gaming systems, and the like.

An online shopping web site evokes the physical analogy of buying products at a brick and mortar store or shopping center. A typical online shopping website enables a customer to view photos or images of a range of products, along with information about the products' specifications, features, and prices. Online shopping customers must have access to the Internet and a valid form of payment, such as a credit card or other form of electronic payment, in order to complete a transaction. For physical products, such as furniture or clothes, the provider ships the physical products to the customer. For digital products, such as music, movies, or software, the provider typically sends the digital products to the customer via the Internet.

Group buying, also known as collective buying, offers products and services at reduced prices on the condition that a minimum number of buyers would make the purchase. Group buying websites have emerged as a major player in online shopping business. Typically, these websites feature a “deal of the day”, with the deal kicking in when a set number of people agree to buy the product or service. Buyers then print off a voucher to claim their discount at the retailer. Many of the group buying websites work by negotiating deals with local merchants and promising to deliver a higher foot count in exchange for better prices.

### SUMMARY

According to one illustrative embodiment, a computer-implemented method for providing a calculus for collaborative online commerce is provided. A computer receives an input to generate a group of online shopping members based on product category of online shopping. The computer retrieves product purchasing affinity quotients of members in a member group corresponding to the product category of online shopping from a member group database. The computer selects a set of members in the member group having a product purchasing affinity quotient above a defined affinity quotient threshold level corresponding to the product category of online shopping. The computer generates the group of online shopping members based on the set of members in the member group having product purchasing affinity quotients above the defined affinity quotient threshold level corresponding to the product category of online shopping. According to other illustrative embodiments, a computer system and computer program product for providing a calculus for collaborative online shopping are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating a single provider environment in accordance with an illustrative embodiment;

FIG. 4 is a diagram illustrating a multi-provider environment in accordance with an illustrative embodiment;

FIG. 5 is a diagram illustrating an example of affinity quotient calculation tables in accordance with an illustrative embodiment;

FIG. 6 is a diagram illustrating an example of member group intersection in accordance with an illustrative embodiment;

FIG. 7 is a flowchart illustrating a process for calculating member affinity quotients in a single provider environment in accordance with an illustrative embodiment;

FIGS. 8A-8B are a flowchart illustrating a process for calculating member affinity quotients in a multi-provider environment in accordance with an illustrative embodiment;

FIG. 9 is a flowchart illustrating a process for updating affinity quotients in accordance with an illustrative embodiment;

FIGS. 10A-10C are a flowchart illustrating a process for purchasing products by a customer in a single provider environment in accordance with an illustrative embodiment;

FIGS. 11A-11C are a flowchart illustrating a process for purchasing products by a customer in a multi-provider environment in accordance with an illustrative embodiment; and

FIG. 12 is a flowchart illustrating a process for determining product discounts for different groups based on group affinity quotient calculated for each respective group in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

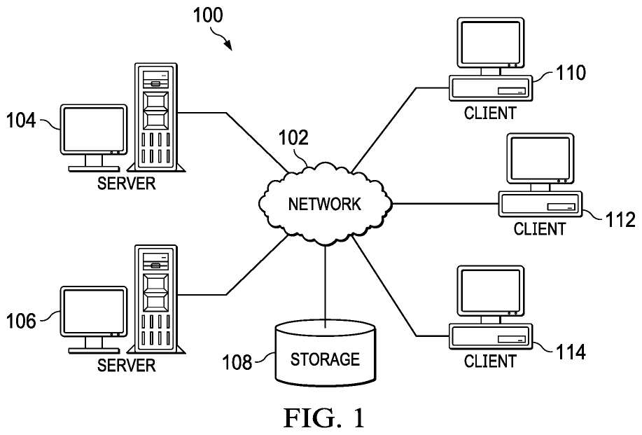

With reference now to the figures, and in particular, with reference to FIGS. 1-4, diagrams of data processing environments are provided in which illustrative embodiments may be implemented. It should be appreciated that FIGS. 1-4 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may provide one or more services, such as, for example, one or more different online shopping services, to client devices. Also, it should be noted that server 104 and server 106 may each represent a cluster of servers in a data center or cloud environment owned and operated by an online product provider. Alternatively, server 104 and server 106 may each represent computing nodes in a data center or cloud environment owned and operated by an online shopping broker that manages online product sales for a plurality of different product providers. An online product provider is a seller, supplier, or source of goods and/or services to online shopping customers.

Further, server 104 and server 106 may provide an online social shopping calculus service to online shopping customers and product providers. For example, server 104 and server 106 may generate product purchasing affinity quotients corresponding to online shopping customers based on customer characteristics. A product purchasing affinity quotient is a measure of an online shopping customer's purchasing power and behavior regarding particular categories of products. Customer characteristics may include, for example, age, income, product preferences, online shopping history, and the like. Furthermore, server 104 and server 106 may generate groups of customers for collaborative online social shopping based on similar characteristics, individual product purchasing affinity quotients of respective online shopping customers, and other factors. Moreover, server 104 and server 106 may provide applications and programs to client devices of online shopping customers.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, laptop computers, handheld computers, smart phones, smart watches, smart televisions, gaming devices, and the like. Users of clients 110, 112, and 114 may utilize clients 110, 112, and 114 to access and utilize the online shopping and social shopping calculus services provided by server 104 and server 106. A client device user may be an online shopping customer or a person associated with an online product provider.

Storage 108 is a network storage device capable of storing any type of data in a structured format or an unstructured format. In addition, storage 108 may represent a plurality of network storage devices. Further, storage 108 may store identifiers and network addresses for a plurality of different servers, identifiers and network addresses for a plurality of different client devices, identifiers for a plurality of different online shopping customers, billing and payment information for the plurality of different online shopping customers, and the like. Furthermore, storage unit 108 may store other types of data, such as authentication or credential data that may include user names, passwords, and biometric data associated with online shopping customers, system administrators, and other users, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), a telecommunications network, or any combination thereof. FIG. 1 is intended as an example only, and not as an architectural limitation for the different illustrative embodiments.

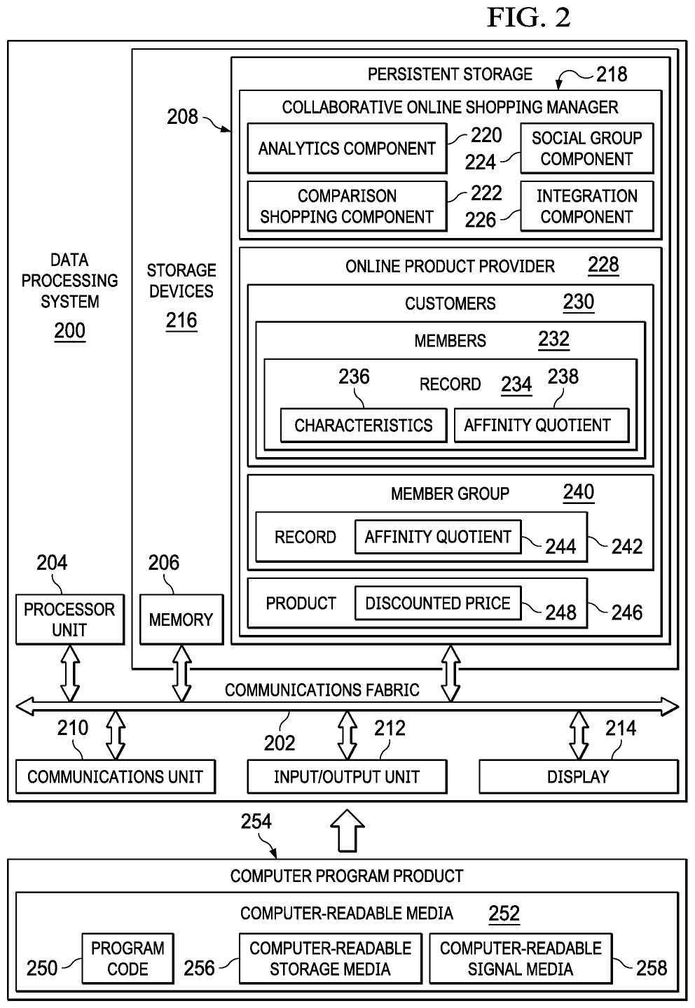

With reference now to FIG. 2, a diagram of a data processing system is depicted in accordance with an illustrative embodiment. Data processing system 200 is an example of a computer, such as server 104 in FIG. 1, in which computer readable program code or instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random-access memory (RAM), or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores collaborative online shopping manager 218. However, it should be noted that even though collaborative online shopping manager 218 is illustrated as residing in persistent storage 208, in an alternative illustrative embodiment collaborative online shopping manager 218 may be a separate component of data processing system 200. For example, collaborative online shopping manager 218 may be a hardware component coupled to communication fabric 202 or a combination of hardware and software components. In another alternative illustrative embodiment, a set of components of collaborative online shopping manager 218 may be located in data processing system 200 and a second set of components of collaborative online shopping manager 218 may be located in a second data processing system, such as, for example, server 106 or client 110 in FIG. 1. In yet another alternative illustrative embodiment, collaborative online shopping manager 218 may be located in client devices instead of, or in addition to, data processing system 200.

Collaborative online shopping manager 218 controls the process of: identifying characteristics of online shopping customers; calculating product purchasing affinity quotients corresponding to the online shopping customers based on identified characteristics; generating different groups of online shopping customers based on similarity of characteristics, calculated product purchasing affinity quotients of individual online shopping customers, and other factors; calculating a group product purchasing affinity quotient corresponding to each group of online shopping customers; and determining product discount pricing for each respective group of online shopping customers based on each group's corresponding product purchasing affinity quotient. A group product purchasing affinity quotient is a measure of product purchasing power and behavior corresponding to a particular group of online shopping customers.

In this example, collaborative online shopping manager 218 includes analytics component 220, comparison shopping component 222, social group component 224, and integration component 226. However, it should be noted that collaborative online shopping manager 218 may include more or fewer components than illustrated. For example, a single component may be split into two or more components, two or more components may be combined into a single component, or components not shown may be added.

Collaborative online shopping manager 218 utilizes analytics component 220 to perform the online social shopping calculus. Utilizing information regarding past online shopping patterns, analytics component 220 can suggest related products and enhance shopping experience for online shopping customers. Further, utilizing information in an online shopping customer database, which may correspond to a single online product provider or multiple online product providers, analytics component 220 can provide intelligence on every online shopping customer and group of online shopping customers to online product providers, which supports effective business. Furthermore, analytics component 220 generates product purchasing affinity quotients for each individual online shopping customer and group of online shopping customers. Moreover, analytics components 220 periodically recompiles product purchasing affinity quotients for each individual and group at expiration of a predefined time interval or occurrence of an event, such as a product purchasing transaction, to keep the product purchasing affinity quotients current and up-to-date.

Collaborative online shopping manager 218 utilizes comparison shopping component 222 across multiple online product providers, particularly when an online shopping broker entity implements collaborative online shopping manager 218. Utilizing information across a plurality of online product provides regarding product pricing, comparison shopping component 222 is able to compare pricing of a particular product offered by different online product providers. As a result, comparison shopping component is able to select a particular product provider having a lowest price for a product of interest, which enhances the online shopping experience for online shopping customers.

Collaborative online shopping manager 218 utilizes social group component 224 to maintain social groups of online shopping customers. Social group component 224 is capable of inviting additional online shopping customers to join an existing social group of online shopping customers. In addition, social group component 224 enables all required communication within a single social group of customers. For example, social group component 224 enables real time audio and video communication for all in the social group of online shopping customers. In addition, social group component 224 enables all in the social group of online shopping customers to view the same product at the same time. Further, social group component 224 enables any individual in the social group of online shopping members to propose a product of interest and draw the attention of the entire group towards that product.

Collaborative online shopping manager 218 utilizes integration component 226 to integrate with online shopping web sites of online product providers. Integration component 226 handles all required hypertext transfer protocol communication to retrieve information from and place orders to online shopping web sites.

Online product provider 228 represents an identifier of a particular supplier of goods and/or services to online shopping customers. However, online product provider 228 may represent identifiers corresponding to a plurality of online product providers associated with an online shopping broker entity. Customers 230 represent a list of online shopping customers corresponding to online product provider 228. Members 232 represent a list of online shopping customers in customers 230 who are members of, for example, a loyalty program or other customer joining program corresponding to online product provider 228.

Record 234 represents stored information regarding a particular member in member 232. However, it should be noted that record 234 represents a record for each respective member in members 232. In this example, record 234 includes characteristics 236 and affinity quotient 238. It should be noted that monitored information and stored information is performed with consent of each user. Furthermore, illustrative embodiments provide mechanisms to obtain user consent via an opt-in/opt-out function. Moreover, illustrative embodiments can transmit an alert to a user when illustrative embodiments are recording and storing information.

Characteristics 236 may include, for example, a unique identifier corresponding to the particular member, age of the member, salary range of the member, and online shopping preferences, such as preferences for certain products, providers, and the like. Characteristics 236 may also include other information, such as current online shopping session information, amount spent during last online shopping session, frequency of online shopping, online shopping history, category or categories of products shopped online, online product provider information associated with the online shopping session, information regarding mannerism of the member (e.g., preferences for cost, brand, style, trend, and the like), which may be obtained from analysis of posted member comments and reviews, and information regarding online shopping behavior of the member (e.g., preferences for casual shopping, discount shopping, holiday shopping, weekend shopping, and the like). However, it should be noted that record 234 may include any type of information corresponding to the member. This information about the member may assist an online product provider in offering attractive product price discount proposals to the member, as well as make the online product provider aware of the member's behavior and mannerism.

Consider a per-ProductCategory N-dimensional scatter plot created out of a mass of customer data that has, for example, on the X-axis the purchasing probability (e.g., dollars spent with a degree of confidence beyond a threshold) in a given period of time (e.g., a month) and on the other N-1 axes, the vector with N-1 elements, such as age, salary, other behavioral attributes, and detected preferences. An artificial intelligence (AI)-based algorithm, such as K-means Clustering, can classify the scatter plot into categories of users (e.g., each category can be a “group”) with an associated purchasing probability/power (the X-axis value). Now, when a new customer comes in, the AI-based algorithm will insert the new customer into the group that is “least distant” from the new customer. Thus, the Al-based algorithm can figure out the closest group that matches with the customer's behavioral and attribute patterns. However, it should be noted that this is only one example of an Al-based (machine learning-based unsupervised learning) technique that can help compose groups out of customers and decide which group(s) a newly arriving customer could potentially be a part of.

Affinity quotient 238 is a product purchasing affinity quotient corresponding to the particular member and gauges and indicates the purchasing power and purchasing behavior of that particular member. Analytics component 220 generates affinity quotient 238 of the member based on characteristics 236.

Member group 240 represents an identifier for a group of members with similar online shopping characteristics or traits regarding a particular category of products, such as, for example, household goods. However, it should be noted that member group 240 may represent a plurality of different member groups corresponding to a plurality of different product categories. Record 242 represents a stored record corresponding to member group 240. In this example, record 242 includes affinity quotient 244. Affinity quotient 244 is a product purchasing affinity quotient corresponding to member group 240 and gauges and indicates the purchasing power and purchasing behavior of that particular group. Analytics component 220 generates affinity quotient 244 based on affinity quotient 238 of each respective member in member group 240.

Product 246 represents a particular product offered for sale by online product provider 228. However, it should be noted that product 246 may represent a plurality of different products corresponding to online product provider 228. In addition, product 246 may be a good or a service.

Discounted price 248 represents a discounted or reduced price for product 246. Analytics component 220 generates discounted price 248 for member group 240 based on affinity quotient 244. In other words, analytics component 220 generates different discount pricing for different member groups based on each respective member group's affinity quotient and other factors, such as geographic location of each respective member group, time of year, and the like.

As a result, data processing system 200 operates as a special purpose computer in which collaborative online shopping manager 218 in data processing system 200 enables collaborative online shopping for different groups of online product provider members within different categories of products. In particular, collaborative online shopping manager 218 transforms data processing system 200 into a special purpose computer as compared to currently available general computer systems that do not have collaborative online shopping manager 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 250 is located in a functional form on computer readable media 252 that is selectively removable and may be loaded onto or transferred to data processing system 200 for running by processor unit 204. Program code 250 and computer readable media 252 form computer program product 254. In one example, computer readable media 252 may be computer readable storage media 256 or computer readable signal media 258. Computer readable storage media 256 may include, for example, an optical or magnetic disc that is inserted or placed into a drive or other device that is part of persistent storage 208 for transfer onto a storage device, such as a hard drive, that is part of persistent storage 208. Computer readable storage media 256 also may take the form of a persistent storage, such as a hard drive, a thumb drive, or a flash memory that is connected to data processing system 200. In some instances, computer readable storage media 256 may not be removable from data processing system 200.

Alternatively, program code 250 may be transferred to data processing system 200 using computer readable signal media 258. Computer readable signal media 258 may be, for example, a propagated data signal containing program code 250. For example, computer readable signal media 258 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 250 may be downloaded over a network to persistent storage 208 from another device or data processing system through computer readable signal media 258 for use within data processing system 200. For instance, program code stored in a computer readable storage media in a data processing system may be downloaded over a network from the data processing system to data processing system 200. The data processing system providing program code 250 may be a server computer, a client computer, or some other device capable of storing and transmitting program code 250.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 256 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Unlike a shopping experience at a brick and mortar store, current online shopping mechanisms do not have a social dimension. Shopping with friends and family members is a common occurrence at brick and mortar stores. In addition, a shopper at a brick and mortar store may find other shoppers interested in the same product and engage with them by asking questions. Compared to this social aspect of brick and mortar stores, current online shopping is limited to only one customer interacting with an online store.

In a social online shopping scenario, a customer may find it easier and more convenient to shop with a group of known people or product experts regarding a particular product category, such as electronics, which the customer is interested in. Thus, it would be helpful for the online shopping customer to dynamically create a group of people with the right product category expertise to shop with.

Illustrative embodiments enable an online shopping customer to view and validate product purchasing affinity quotients of other online shopping customers prior creating a group of customers. A group of customers with a high group product purchasing affinity quotient is bound to get noticed by the online product providers. As a result, these online product providers may extend group level offers and discounts, which is a win-win for the online shopping customer and online product provider.

Illustrative embodiments generate a calculus for social shopping that provides online product providers with intelligence to judge and engage different groups of customers, which targets more business. The calculus provides an online product provider with means of creating customer groups based on various factors, which improves business prospects. Cognitive analytics of illustrative embodiments support periodic recompiling of customer group data resulting in updated intelligence on a regular basis. By utilizing cognitive analytics, illustrative embodiments recompile the data frequently and, therefore, provide realistic and precise member and group affinity quotients.

Thus, illustrative embodiments provide one or more technical solutions that overcome a technical problem with online shopping isolation by automatically generating groups of online shopping members corresponding to a particular product category to increase consumer confidence and purchasing power and decrease cost and effort. This is different from how humans currently approach the problem (e.g., by going to a stranger in a store and asking the stranger for an opinion on a product). Illustrative embodiments can create groups of people that have similar interests and can provide the user with feedback. In addition, illustrative embodiments maximize profit of online product providers by increasing sales volumes based on targeted member incentives and discounts. As a result, these one or more technical solutions may provide a technical effect in the field of online shopping.

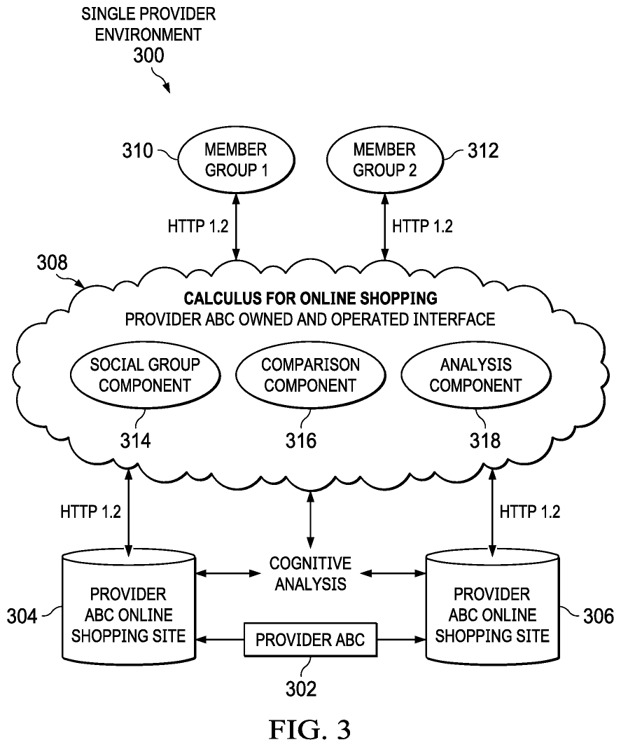

With reference now to FIG. 3, a diagram illustrating a is depicted in accordance with an illustrative embodiment. Single provider environment 300 may be implemented in a network of data processing systems, such as network data processing system 100 in FIG. 1. Single provider environment 300 represents a single online product provider owned and operated web site and interface.

In this example, single provider environment 300 includes provider ABC 302, provider ABC online shopping site 304, provider ABC online shopping site 306, provider ABC owned and operated interface 308, member group 1 310, and member group 2 312. However, it should be noted that single provider environment 300 may include any number of member groups. Also, provider ABC owned and operated interface 308 includes social group component 314, comparison component 316, and analysis component 318, such as social group component 224, comparison shopping component 222, and analytics component 220 in FIG. 2.

Provider ABC 302 manages the customer/member database, as well as the cognitive analytics applications. In single provider environment 300, analysis component 318 only applies cognitive analysis on “N” number of customer/member records stored in provider ABC 302's customer/member database. On arrival of a new customer to provider ABC owned and operated interface 308, provider ABC 302 does not have any information regarding the customer and is forced to start cognitive analysis with an initial product purchasing affinity quotient based on characteristics (e.g., age, interests, and the like) provided by the customer or retrieved from one or more online data sources, such as social media websites. This initial product purchasing affinity quotient has an impact on the group product purchasing affinity quotient of the member group, such as member group 1 310, to which the new customer joins or to which social group component 314 assigns the new customer to based on similarity of characteristics with other customers.

Even though provider ABC 302 receives intelligence regarding the new customer with time, the time taken may be directly proportional to the number of new customers engaging with provider ABC 302. In addition, generating new member groups based on similar characteristics may not be helpful due to a limited number of customers in the customer/member database. As a result, periodic recompiling of both individual and group product purchasing affinity quotients may not be realistic due to limited amount of customer data.

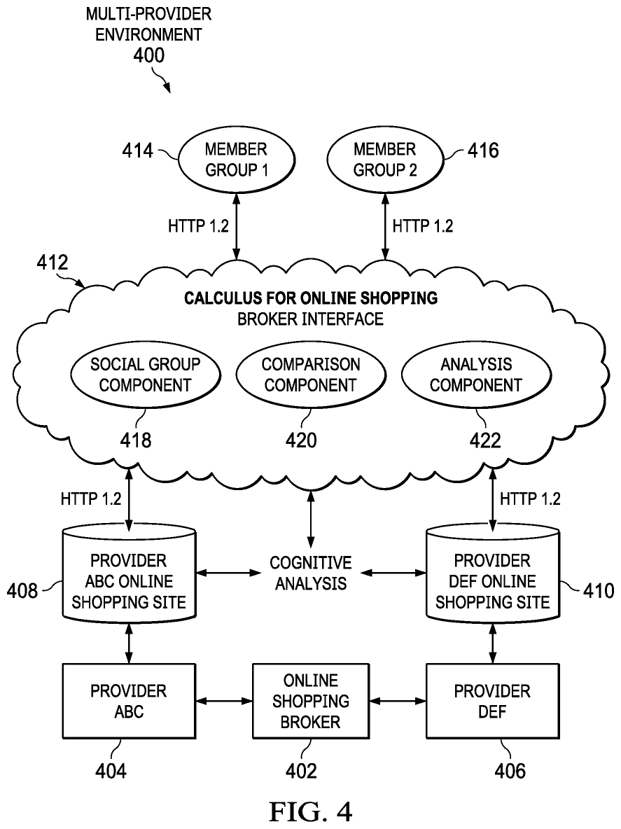

With reference now to FIG. 4, a diagram illustrating a multi-provider environment is depicted in accordance with an illustrative embodiment. Multi-provider environment 400 may be implemented in a network of data processing systems, such as network data processing system 100 in FIG. 1. Multi-provider environment 400 represents an online shopping broker owned and operated web site and interface for a plurality of online product providers. In other words, the broker interface provides cross provider intelligence and may be deployed as a multi-provider broker service in a cloud environment, for example.

In this example, multi-provider environment 400 includes online shopping broker 402, provider ABC 404, provider DEF 406, provider ABC online shopping site 408, provider DEF online shopping site 410, broker owned and operated interface 412, member group 1 414, and member group 2 416. However, it should be noted that multi-provider environment 400 may include any number of online product providers, web sites, and member groups. Also, broker owned and operated interface 412 includes social group component 418, comparison component 420, and analysis component 422, such as social group component 224, comparison shopping component 222, and analytics component 220 in FIG. 2.

Multi-provider environment 400 exploits a multi-provider brokerage application with inbuilt cognitive analysis capability. All online customer shopping orders and transactions flow through broker interface 412, which strengthens the customer/member database with every order and transaction. This customer/member database enhances cross provider intelligence and helps target more business.

Any new customer engaging with a provider, such as provider ABC 404, of online shopping broker 402 for the first time may have a history of transactions with one or more other providers, such as provider DEF 406, of online shopping broker 402 and, therefore, intelligence about the customer would be available in the customer/member database. It should be noted that the sharing of consumer histories and trends is performed with user consent. As a result, generating new groups of members based on similar characteristics will be much easier due to the large data pool of customer/member information across the various online product providers. Consequently, periodic recompiling of both individual and group product purchasing affinity quotients will be more realistic due to the extensive customer/member data pool.

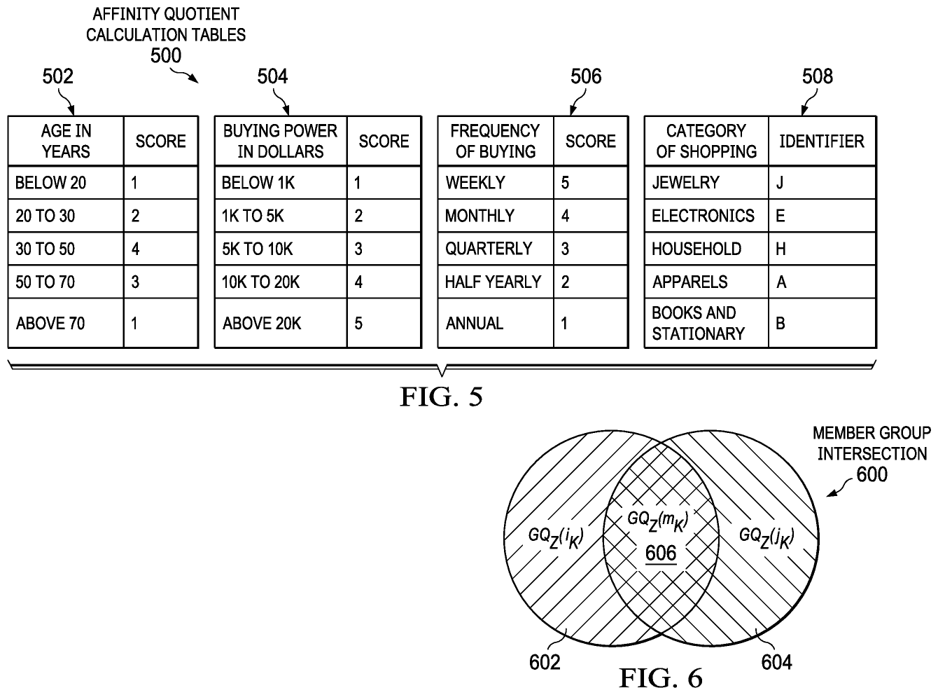

With reference now to FIG. 5, a diagram illustrating an example of affinity quotient calculation tables is depicted in accordance with an illustrative embodiment. Affinity quotient calculation tables 500 represents a set of tables that an analytics component, such as analytics component 220 in FIG. 2, utilizes to calculate a product purchasing affinity quotient for an online product provider member.

In this example, affinity quotient calculation tables 500 include table 502, table 504, table 506, and table 508. However, it should be noted that affinity quotient calculation tables 500 are meant as examples only and may include any number and type of tables.

Table 502 lists ranges of age with a corresponding affinity quotient score. For example, members below age 20 are assigned an affinity quotient score of 1, members between ages of 20 and 30 are assigned an affinity quotient score of 2, members between ages of 30 and 50 are assigned an affinity quotient score of 4, members between ages of 50 and 70 are assigned an affinity quotient score of 3, and members above the age of 70 are assigned an affinity quotient score of 1. Table 504 lists ranges of buying power in dollars with a corresponding affinity quotient score. For example, members with buying power below $1,000.00 are assigned an affinity quotient score of 1, members with buying power between $1,000.00 and $5,000.00 are assigned an affinity quotient score of 2, members with buying power between $5,000.00 and $10,000.00 are assigned an affinity quotient score of 3, members with buying power between $10,000.00 and $20,000.00 are assigned an affinity quotient score of 4, and members with buying power above $20,000.00 are assigned an affinity quotient score of 5.

Table 506 lists buying frequency with a corresponding affinity quotient score. For example, members with a weekly buying frequency are assigned an affinity quotient score of 5, members with a monthly buying frequency are assigned an affinity quotient score of 4, members with a quarterly buying frequency are assigned an affinity quotient score of 3, members with a half yearly or biannual buying frequency are assigned an affinity quotient score of 2, and members with a yearly buying frequency are assigned an affinity quotient score of 1. Table 508 lists shopping categories with a corresponding identifier. For example, a jewelry shopping category has a “J” identifier, an electronics shopping category has an “E” identifier, a household shopping category has an “H” identifier, an apparel shopping category has an “A” identifier, and a books and stationary shopping category has a “B” identifier.

The analytics component may calculate a product purchasing affinity quotient (AQ) corresponding to a particular member based on one or more of age, buying power, buying frequency, and category. The analytics component may also take into consideration other factors, such as shopping history (e.g., time since last online shopping activity, last amount spent during an online shopping session, online product provider involved, and the like). However, the analytics component may reduce an affinity quotient of a member if the member has been inactive for a defined threshold amount of time.

Using the tables above, the analytics component may calculate an AQ for a member as shown below:

AQ_{z}(i)=Sum of Scores (Age of ‘i’, Buying power of ‘i’, Shopping frequency of ‘i’). As an example, AQ of John (‘i’), corresponding to electronics shopping category (‘E’), may be as follows: John is age 35 (score 4), buying power is $5,000.00 to $10,000.00 (score 3), and buying frequency is quarterly (score 3). Thus, AQ_{E}(John) is 4+3+3=10. It should be noted that an AQ of a member may vary based on the shopping category. In other words, the AQ of John when the category of interest is electronics may be different from his AQ when the category of interest is household goods.

The analytics component may also calculate a product purchasing affinity quotient (GQ) corresponding to a particular group of members, which includes John, based on the AG of each respective member in the group for a particular category. The analytics component may assume that the size of the member group has “K” number of members. The analytics component may also take into consideration other factors, such as shopping history (e.g., time since last online shopping activity, last amount spent during an online shopping session, online product provider involved, and the like). However, the GQ is a function of time and the analytics component may reduce the GQ if the group or a member in the group has been inactive for a defined threshold amount of time.

The analytics component may calculate the GQ as shown below:

$${GQ}_{Z} ( {i}_{K} ) = \{ {\sum }_{z = 0}^{K - 1} {AQ}_{Z} [ {memberx}_{( {i}_{K} )} ] \} / K ,$$

where AQ_{z}[memberₓ(iₖ)] is a scalar representing the AQ value for an individual member, ‘(i_{K})’ represents a vector ‘i’ (i.e., group ID) with ‘K’ number of online shoppers, ‘x’ carries a value from 0 to ‘K-1’, ‘memberₓ(i_{K})’ is the ‘xth’ member of the vector ‘i’, and ‘Z’ represents the category of interest pertaining to the group. It should be noted that members of a group need not be related to one another. Further, the analytics component periodically recomputes the GQ of every group and the new GQ value is based on the change in the AQ of every member in the group.

With reference now to FIG. 6, a diagram illustrating an example of member group intersection is depicted in accordance with an illustrative embodiment. Member group intersection 600 represents an intersection of existing groups GQ_{z}(i_{K}) 602 and GQ_{z}(j_{K}) 604 of online shopping members, culminating in a new group of members GQ_{z}(m_{K}) 606 based on common characteristics or characteristics selected by an online shopping member or provider.

Similar to the example above:

$$\begin{matrix}{GQ}_{Z} ( {i}_{K} ) = \{ {\sum }_{z = 0}^{K - 1} AQz [ {memberx}_{( {i}_{K} )} ] \} / K and & Group ' i ' \\ {GQ}_{Z} ( {j}_{K} ) = \{ {\sum }_{z = 0}^{K - 1} {AQ}_{z} [ {memberx}_{( {j}_{K} )} ] \} / K , & Group ' j '\end{matrix}$$

where ‘i’ & ‘j’ represent the Group IDs, ‘K’ represents the number of members in each group and ‘x’ carries a value from 0 to ‘K-1’. GQ_{z}(m_{K}) 606 is formed by the intersection of GQ_{z}(i_{K}) 602 and GQ_{z}(j_{K}) 604. The intersection is formed by members chosen based on similarity of characteristics, such as buying trends, employees of the same company, geographic location, and the like.

The GQ of the new group with ID ‘m’ is represented by GQ_{z}(m_{K}), but the total number of members of the new groups is still ‘K’. For example:

$${GQ}_{Z} ( {m}_{K} ) = {GQ}_{Z} ( {j}_{K} ) + {GQ}_{Z} ( {j}_{K} ) - {\sum }_{z = 0}^{K \hat{}} {AQ}_{Z} [ memberx ( {i}_{X \hat{}} ) ] - {\sum }_{z = 0}^{K \hat{}} {AQ}_{Z} [ memberx ( {j}_{X \hat{}} ) ] , \qquad Group ' m '$$

where the vector ‘m_{K}’ is derived from the intersection of the two vectors ‘iₖ’ and ‘jₖ’. However, the AQ_{z} values of all the members of GQ_{z}(i_{K}) 602 and GQ_{z}(j_{K}) 604 not joining GQ_{z}(m_{K}) 606 will need to be removed. ‘K’ represents the count of these members.

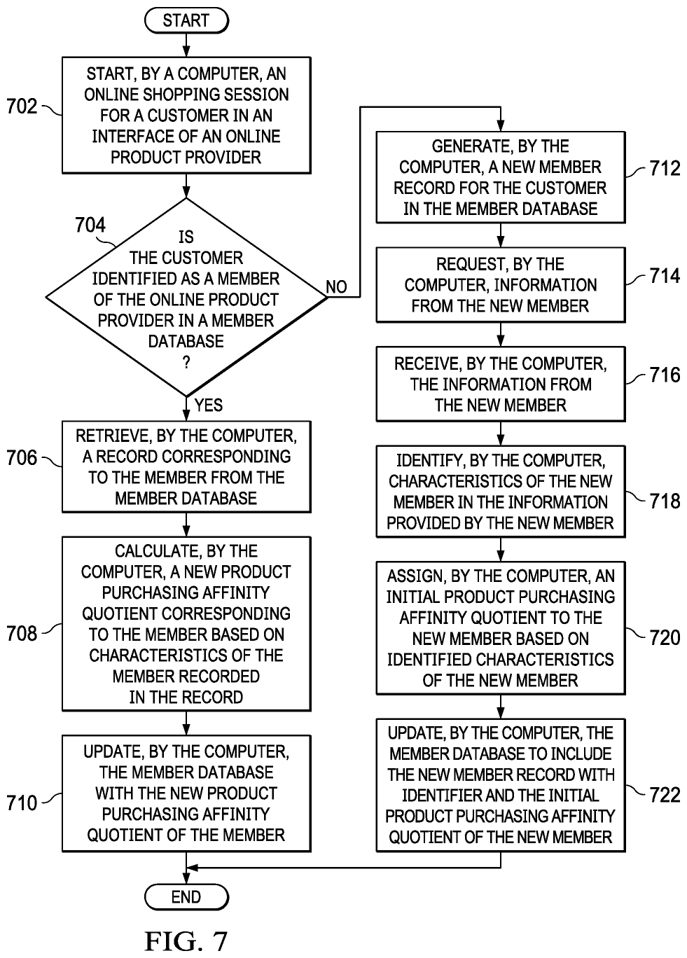

With reference now to FIG. 7, a flowchart illustrating a process for calculating member affinity quotients in a single provider environment is shown in accordance with an illustrative embodiment. The process shown in FIG. 7 may be implemented in a computer, such as, for example, server 104 in FIG. 1 or data processing system 200 in FIG. 2.

The process begins when the computer starts an online shopping session for a customer in an interface of an online product provider (step 702). The computer makes a determination as to whether the customer is identified as a member of the online product provider in a member database of the online product provider (step 704). If the computer determines that the customer is identified as a member of the online product provider in the member database, yes output of step 704, then the computer retrieves a record corresponding to the member from the member database (step 706). The computer calculates a new product purchasing affinity quotient corresponding to the member based on characteristics of the member recorded in the record (step 708). The characteristics of the member may include, for example, age, buying power, buying frequency, historical product purchasing transaction data, current product purchasing transaction, product category of purchase, member loyalty points awarded by the online product provider for purchases, and the like. In addition, the computer updates the member database with the new product purchasing affinity quotient of the member (step 710). Thereafter, the process terminates.

Returning again to step 704, if the computer determines that the customer is not identified as a member of the online product provider in the member database, no output of step 704, then the computer generates a new member record for the customer in the member database (step 712). Further, the computer requests information from the new member (step 714). The information may include, for example, name, address, marital status, salary, product interests and preferences, job title, employer, and the like. Subsequently, the computer receives the information from the new member (step 716).

The computer identifies characteristics of the new member in the information provided by the new member (step 718). The computer assigns an initial product purchasing affinity quotient to the new member based on identified characteristics of the new member (step 720). Furthermore, the computer updates the member database to include the new member record with identifier and the initial product purchasing affinity quotient of the new member (step 722). Thereafter, the process terminates.

At this point, the member either logs out of the online shopping session or continues shopping. Based on the interest or product category of shopping, the computer provides the member with an option to create a group of members, such as, for example, friends, family, and/or product experts, for a collaborative online shopping experience. Upon creating the group, the computer utilizes the calculus to arrive at a group product purchasing affinity quotient based on individual member affinity quotients of all the members in the group. Based on the calculated group product purchasing affinity quotient, the computer offers incentives or other product discounts to the group to increase product sales and maximize online product provider.

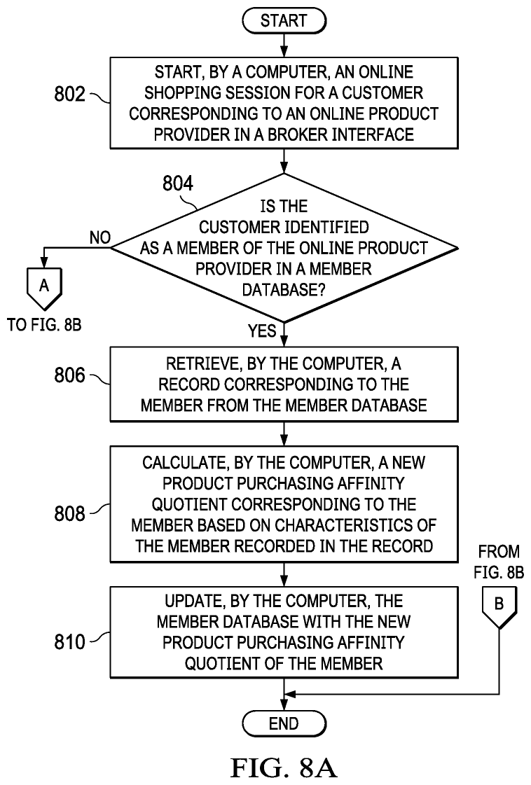

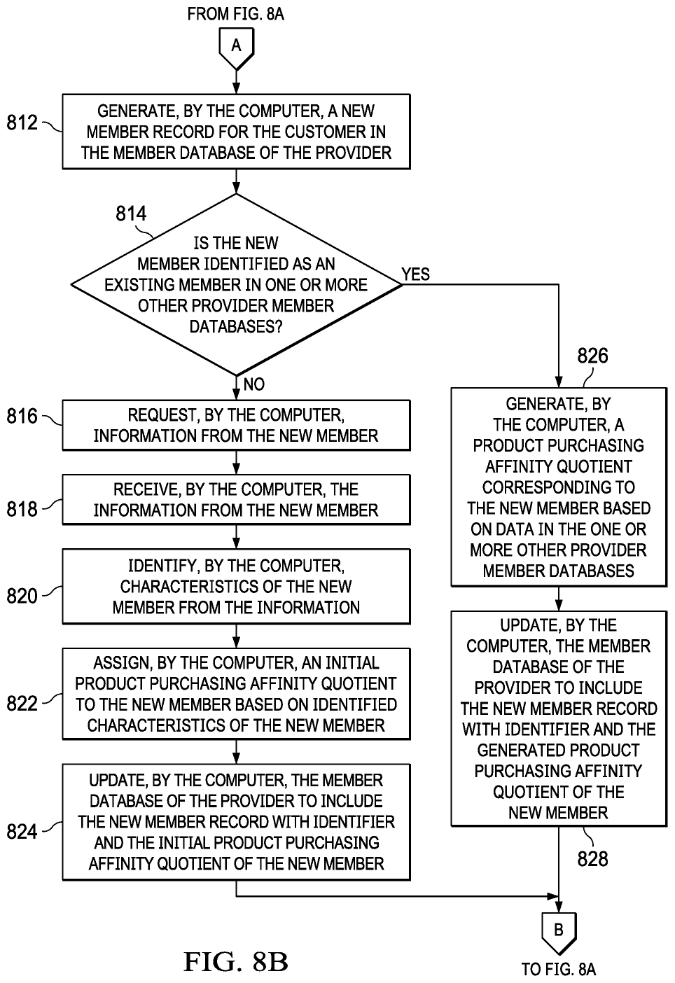

With reference now to FIGS. 8A-8B, a flowchart illustrating a process for calculating member affinity quotients in a multi-provider environment is shown in accordance with an illustrative embodiment. The process shown in FIGS. 8A-8B may be implemented in a computer, such as, for example, server 104 in FIG. 1 or data processing system 200 in FIG. 2.

The process begins when the computer starts an online shopping session for a customer corresponding to an online product provider in a broker interface (step 802). It should be noted that the broker interface corresponds to a multi-provider environment, such as multi-provider environment 400 in FIG. 4. The computer makes a determination as to whether the customer is identified as a member of the online shopping provider in a member database of the online shopping provider (step 804). If the computer determines that the customer is identified as a member of the provider in the member database, yes output of step 804, then the computer retrieves a record corresponding to the member from the member database (step 806). Further, the computer calculates a new product purchasing affinity quotient corresponding to the member based on characteristics of the member recorded in the record (step 808). Furthermore, the computer updates the member database with the new product purchasing affinity quotient of the member (step 810). Thereafter, the process terminates.

Returning again to step 804, if the computer determines that the customer is not identified as a member of the online product provider in the member database, no output of step 804, then the computer generates a new member record for the customer in the member database (step 812). In addition, the computer makes a determination as to whether the new member is identified as an existing member in one or more other provider member databases (step 814). If the computer determines that the new member is not identified as an existing member in one or more other provider member databases, no output of step 814, then the computer requests information from the new member (step 816). Subsequently, the computer receives the information from the new member (step 818).

The computer identifies characteristics of the new member from the information received from the new member (step 820). Moreover, the computer assigns an initial product purchasing affinity quotient to the new member based on identified characteristics of the new member (step 822). The computer also updates the member database of the online product provider to include the new member record with identifier and the initial product purchasing affinity quotient of the new member (step 824). Thereafter, the process terminates.

Returning again to step 814, if the computer determines that the new member is identified as an existing member in one or more other provider member databases, yes output of step 814, then the computer generates a product purchasing affinity quotient corresponding to the new member based on data in the one or more other provider member databases (step 826). Further, the computer updates the member database of the online product provider to include the new member record with identifier and the generated product purchasing affinity quotient of the new member (step 828). Thereafter, the process terminates.

At this point, the member either logs out of the online shopping session or continues shopping. Based on the interest or product category of shopping, the computer provides the member with an option to create a group of members, such as, for example, friends, family, and/or product experts, for a collaborative online shopping experience. Upon creating the group, the computer utilizes the calculus to arrive at a group product purchasing affinity quotient based on individual member affinity quotients of all the members in the group. Based on the calculated group product purchasing affinity quotient, the computer offers incentives or other product discounts to the group to increase product sales and maximize online product provider.

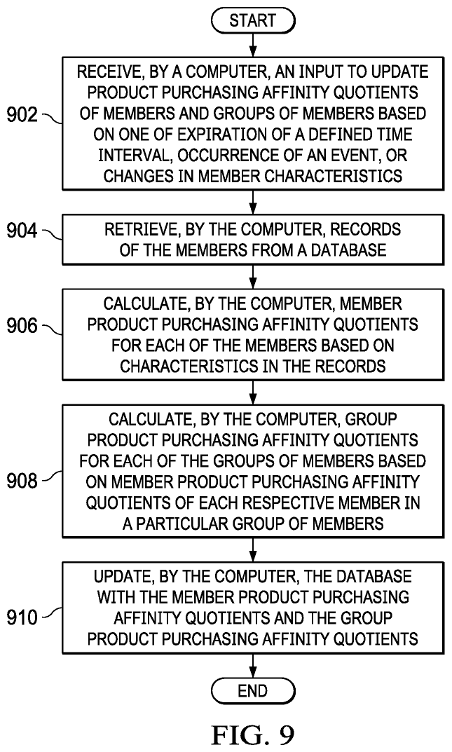

With reference now to FIG. 9, a flowchart illustrating a process for updating affinity quotients is shown in accordance with an illustrative embodiment. The process shown in FIG. 9 may be implemented in a computer, such as, for example, server 104 in FIG. 1 or data processing system 200 in FIG. 2.

The process begins when the computer receives an input to update product purchasing affinity quotients of members and groups of members (step 902). The input may be automatically initiated by the computer, itself, on a predetermined time interval basis, on occurrence of an event, such as a transaction to purchase one or more products by a member or group of members, or on occurrence of changes in member characteristics, such changes in marital status, employment, salary, group membership, and the like. In response to the computer receiving the input to update the product purchasing affinity quotients in step 902, the computer retrieves records of the members from a database (step 904).

The computer calculates member product purchasing affinity quotients for each of the members based on characteristics of the members in the records (step 906). In addition, the computer calculates group product purchasing affinity quotients for each of the groups of members based on member product purchasing affinity quotients of each respective member in a particular group of members (step 908). Afterward, the computer updates the database with the member product purchasing affinity quotients and the group product purchasing affinity quotients (step 910). Thereafter, the process terminates.

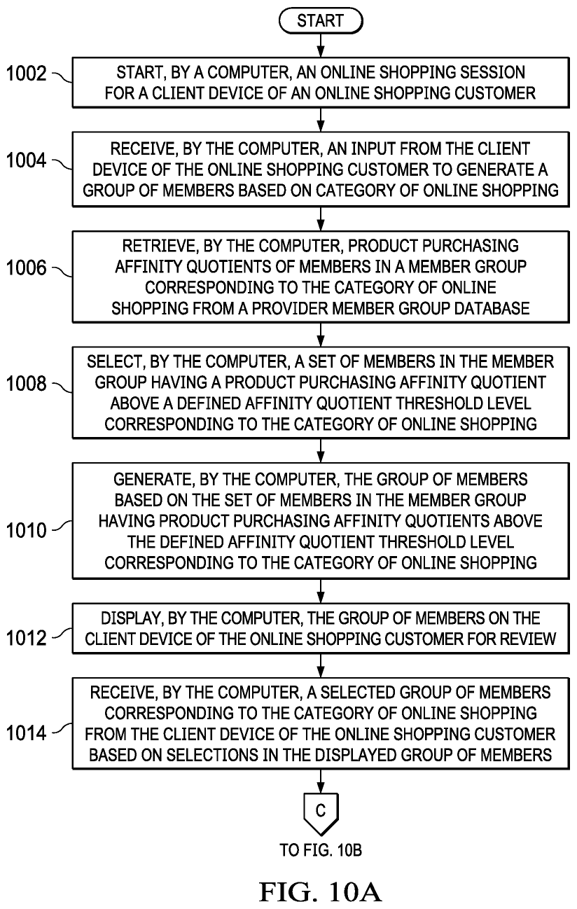

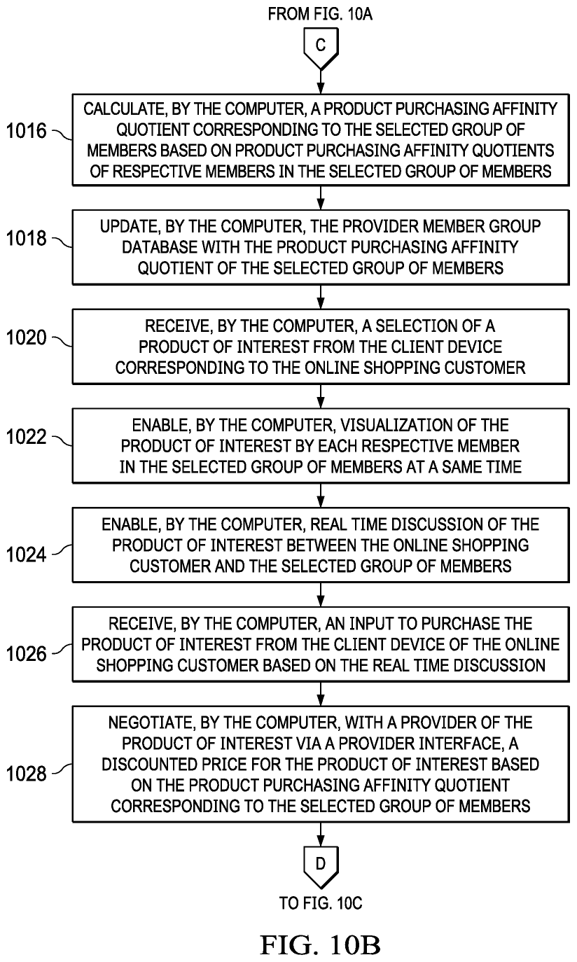

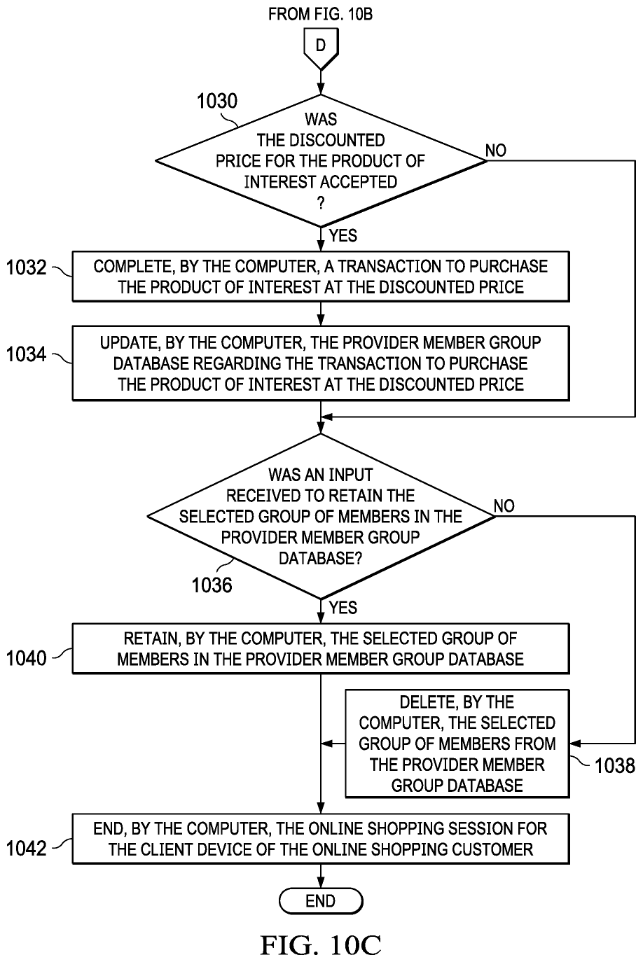

With reference now to FIGS. 10A-10C, a flowchart illustrating a process for purchasing products by a customer in a single provider environment is shown in accordance with an illustrative embodiment. The process shown in FIGS. 10A-10C may be implemented in a computer, such as, for example, server 104 in FIG. 1 or data processing system 200 in FIG. 2.

The process begins when the computer starts an online shopping session for a client device of an online shopping customer (step 1002). In addition, the computer receives an input from the client device of the online shopping customer to generate a group of members based on category of online shopping (step 1004). However, it should be noted that the input need not be received from an online shopping customer device alone. The input may be received from an online product provider who discerns contours of groups of members, when targeted, show a net purchasing probability greater than the sum of constituent members. In addition, the online product provider may generate a soliciting workflow to collect member approvals to complete group creation. The category of online shopping may be any type of category, such as electronics, hardware, food, pet supplies, and the like.

The computer retrieves product purchasing affinity quotients of members in a member group corresponding to the category of online shopping from a provider member group database (step 1006). The computer selects a set of members in the member group having a product purchasing affinity quotient above a defined affinity quotient threshold level corresponding to the category of online shopping (step 1008). The computer generates the group of members based on the set of members in the member group having product purchasing affinity quotients above the defined affinity quotient threshold level corresponding to the category of online shopping (step 1010).

The computer displays the group of members on the client device of the online shopping customer for review (step 1012). Subsequently, the computer receives a selected group of members corresponding to the category of online shopping from the client device of the online shopping customer based on selections in the displayed group of members (step 1014). In other words, the online shopping customer may select all members of the selected group of members or only a portion of those members. Further, the online shopping customer may add other members to the list not previously included in the selected group of members.

The computer calculates a product purchasing affinity quotient corresponding to the selected group of members based on product purchasing affinity quotients of respective members in the selected group of members (step 1016). The computer updates the provider member group database with the product purchasing affinity quotient of the selected group of members (step 1018).

Further, the computer receives a selection of a product of interest from the client device corresponding to the online shopping customer (step 1020). The computer enables visualization of the product of interest by each respective member in the selected group of members at a same time (step 1022). In addition, the computer enables real time discussion of the product of interest between the online shopping customer and the selected group of members (step 1024).

Subsequently, the computer receives an input to purchase the product of interest from the client device of the online shopping customer based on the real time discussion (step 1026). The computer negotiates, with a provider of the product of interest via a provider interface, a discounted price for the product of interest based on the product purchasing affinity quotient corresponding to the selected group of members (step 1028).

The computer makes a determination as to whether the discounted price for the product of interest was accepted (step 1030). If the computer determines that the discounted price for the product of interest was not accepted, no output of step 1030, then the process proceeds to step 1036. If the computer determines that the discounted price for the product of interest was accepted, yes output of step 1030, then the computer completes a transaction to purchase the product of interest at the discounted price (step 1032). The computer also updates the provider member group database regarding the transaction to purchase the product of interest at the discounted price (step 1034).

Afterward, the computer makes a determination as to whether an input was received from the client device of the online shopping customer to retain the selected group of members in the provider member group database (step 1036). If the computer determines that an input was not received to retain the selected group of members in the provider member group database, no output of step 1036, then the computer deletes the selected group of members from the provider member group database (step 1038). Thereafter, the process proceeds to step 1042. If the computer determines that an input was received from the client device of the online shopping customer to retain the selected group of members in the provider member group database, yes output of step 1036, then the computer retains the selected group of members in the provider member group database (step 1040). Subsequently, the computer ends the online shopping session for the client device of the online shopping customer (step 1042). Thereafter, the process terminates.

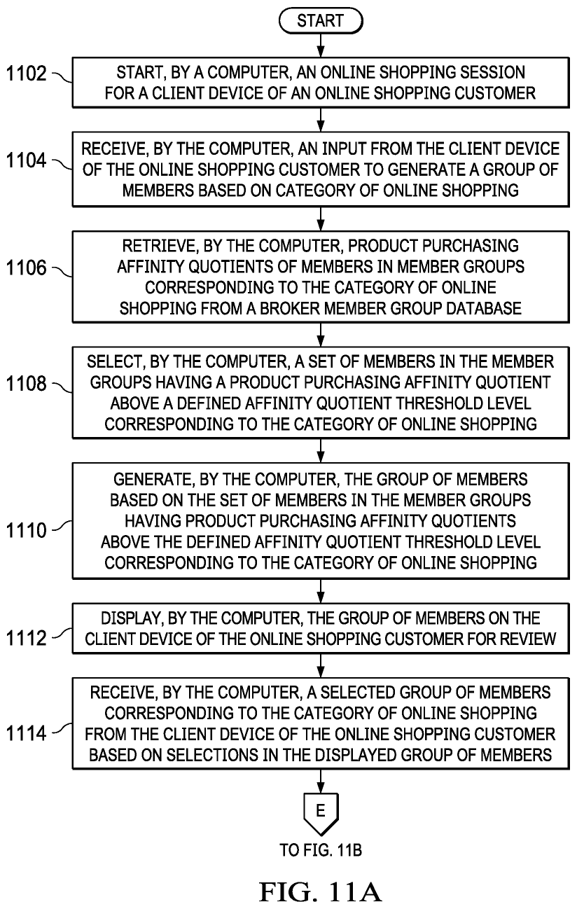

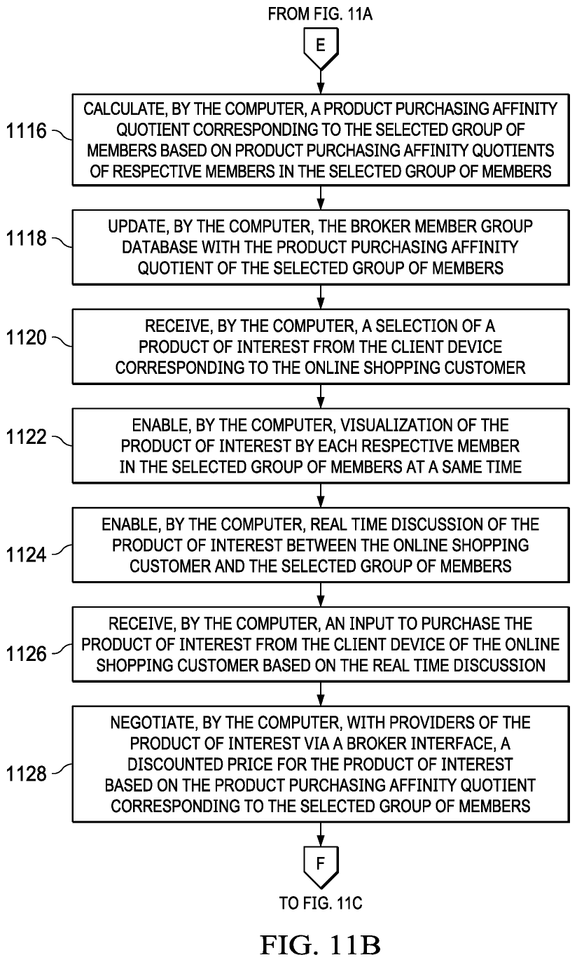

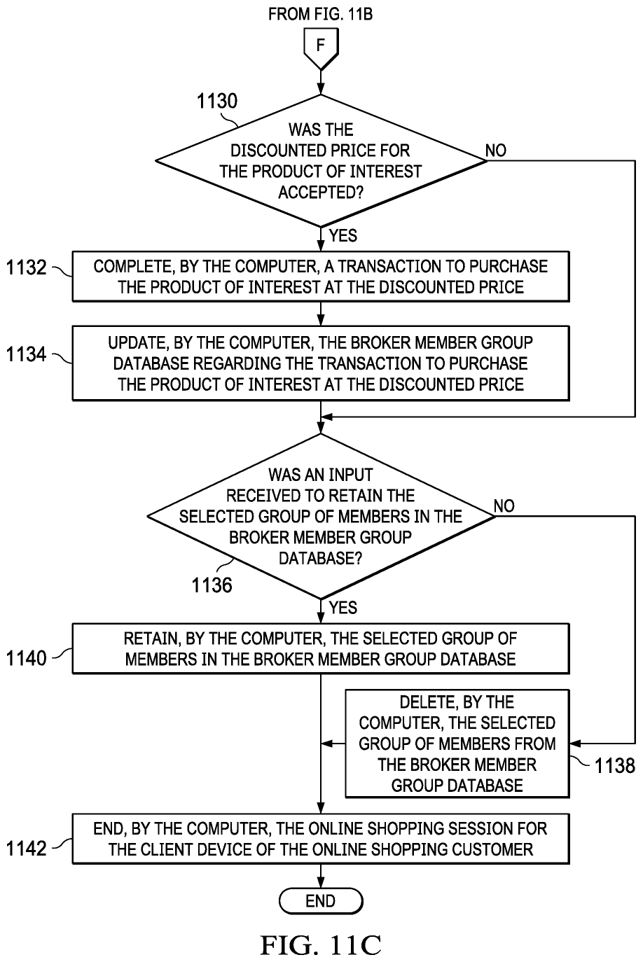

With reference now to FIGS. 11A-11C, a flowchart illustrating a process for purchasing products by a customer in a multi-provider environment is shown in accordance with an illustrative embodiment. The process shown in FIGS. 11A-11C may be implemented in a computer, such as, for example, server 104 in FIG. 1 or data processing system 200 in FIG. 2.

The process begins when the computer starts an online shopping session for a client device of an online shopping customer (step 1102). In addition, the computer receives an input from the client device of the online shopping customer to generate a group of members based on category of online shopping (step 1104). The computer retrieves product purchasing affinity quotients of members in member groups corresponding to the category of online shopping from a broker member group database (step 1106).

The computer selects a set of members in the member groups having a product purchasing affinity quotient above a defined affinity quotient threshold level corresponding to the category of online shopping (step 1108). The computer generates the group of members based on the set of members in the member groups having product purchasing affinity quotients above the defined affinity quotient threshold level corresponding to the category of online shopping (step 1110). The computer displays the group of members on the client device of the online shopping customer for review (step 1112).

Subsequently, the computer receives a selected group of members corresponding to the category of online shopping from the client device of the online shopping customer based on selections in the displayed group of members (step 1114). The computer calculates a product purchasing affinity quotient corresponding to the selected group of members based on product purchasing affinity quotients of respective members in the selected group of members (step 1116). The computer updates the broker member group database with the product purchasing affinity quotient of the selected group of members (step 1118).

The computer receives a selection of a product of interest from the client device corresponding to the online shopping customer (step 1120). The computer enables visualization of the product of interest by each respective member in the selected group of members at a same time (step 1122). The computer also enables real time discussion of the product of interest between the online shopping customer and the selected group of members (step 1124).

The computer receives an input to purchase the product of interest from the client device of the online shopping customer based on the real time discussion (step 1126). The computer negotiates, with providers of the product of interest via a broker interface, a discounted price for the product of interest based on the product purchasing affinity quotient corresponding to the selected group of members (step 1128).

The computer makes a determination as to whether the discounted price for the product of interest was accepted (step 1130). If the computer determines that the discounted price for the product of interest was not accepted, no output of step 1130, then the process proceeds to step 1136. If the computer determines that the discounted price for the product of interest was accepted, yes output of step 1130, then the computer completes a transaction to purchase the product of interest at the discounted price (step 1132). Further, the computer updates the broker member group database regarding the transaction to purchase the product of interest at the discounted price (step 1134).

The computer makes a determination as to whether an input was received from the client device of the online shopping customer to retain the selected group of members in the broker member group database (step 1136 ). If the computer determines that an input was not received to retain the selected group of members in the broker member group database, no output of step 1136, then the computer deletes the selected group of members from the broker member group database (step 1138). Thereafter, the process proceeds to step 1142. If the computer determines that an input was received to retain the selected group of members in the broker member group database, yes output of step 1136, then the computer retains the selected group of members in the broker member group database (step 1140). Subsequently, the computer ends the online shopping session for the client device of the online shopping customer (step 1142). Thereafter, the process terminates.

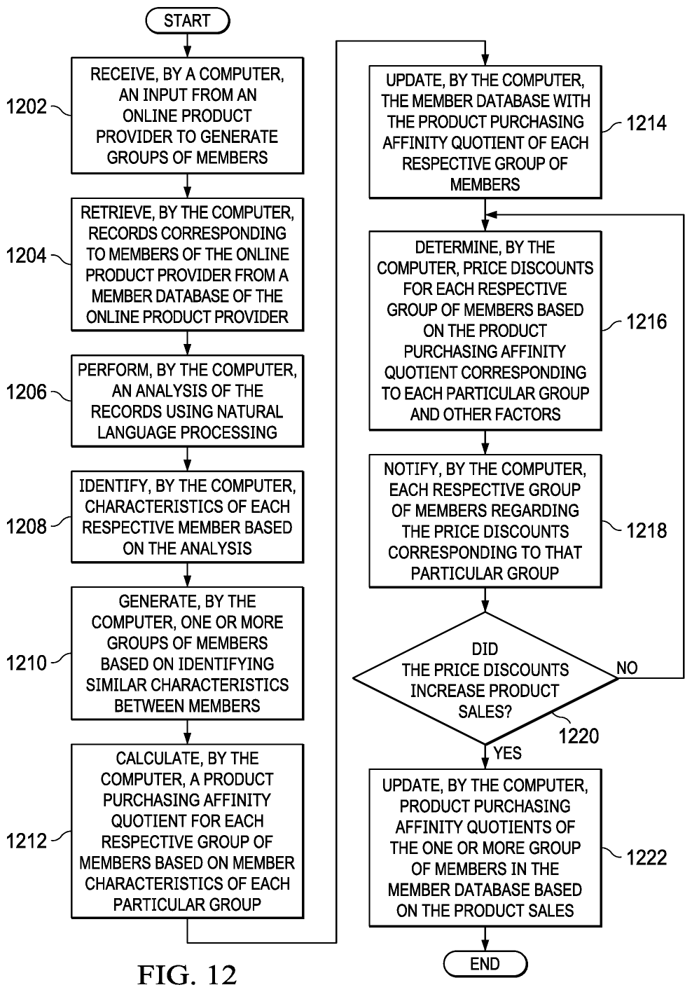

With reference now to FIG. 12, a flowchart illustrating a process for determining product discounts for different groups based on group affinity quotient calculated for each respective group is shown in accordance with an illustrative embodiment. The process shown in FIG. 12 may be implemented in a computer, such as, for example, server 104 in FIG. 1 or data processing system 200 in FIG. 2.

The process begins when the computer receives an input from an online product provider to generate groups of members (step 1202). The computer retrieves records corresponding to members of the online product provider from a member database of the online product provider (step 1204). Further, the computer performs an analysis of the records using natural language processing (step 1206).

The computer identifies characteristics of each respective member based on the analysis (step 1208). The computer generates one or more groups of members based on identifying similar characteristics between members (step 1210). The computer calculates a product purchasing affinity quotient for each respective group of members based on member characteristics of each particular group (step 1212). In addition, the computer updates the member database with the product purchasing affinity quotient of each respective group of members (step 1214).

The computer determines price discounts for each respective group of members based on the product purchasing affinity quotient corresponding to each particular group and other factors (step 1216). Other factors may include, for example, geographic location of each respective group, time of the year, special occasions, such as holidays, and the like. The computer notifies each respective group of members regarding the price discounts corresponding to that particular group (step 1218).

The computer makes a determination as to whether the price discounts increased product sales of the online product provider (step 1220). In other words, the computer determines whether the price discounts were successful in prompting groups to buy products. If the computer determines that the price discounts did not increase product sales of the online product provider, no output of step 1220, then the process returns to step 1216 where the computer determines new price discounts. If the computer determines that the price discounts did increase product sales of the online product provider, yes output of step 1220, then the computer updates product purchasing affinity quotients of the one or more group of members in the member database based on the product sales (step 1222). Thereafter, the process terminates.

Thus, illustrative embodiments of the present invention provide a computer-implemented method, computer system, and computer program product for providing a calculus for collaborative online commerce. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by a computer, an input to generate a group of online shopping members based on product category of online shopping;
retrieving, by the computer, product purchasing affinity quotients of members in a member group corresponding to the product category of online shopping from a member group database;
selecting, by the computer, a set of members in the member group having a product purchasing affinity quotient above a defined affinity quotient threshold level corresponding to the product category of online shopping; and
generating, by the computer, the group of online shopping members based on the set of members in the member group having product purchasing affinity quotients above the defined affinity quotient threshold level corresponding to the product category of online shopping.

2. The computer-implemented method of claim 1 further comprising:
displaying, by the computer, the group of online shopping members on a client device of an online shopping customer;
receiving, by the computer, a selected group of members corresponding to the product category of online shopping from the client device of the online shopping customer based on selections in the displayed group of online shopping members;
calculating, by the computer, a product purchasing affinity quotient corresponding to the selected group of members based on product purchasing affinity quotients of respective members in the selected group of members; and
updating, by the computer, the member group database with the product purchasing affinity quotient of the selected group of members.

3. The computer-implemented method of claim 1 further comprising:
generating, by the computer, groups of online shopping members based on identifying similar member characteristics;
calculating, by the computer, a product purchasing affinity quotient for each respective group of online shopping members based on identified member characteristics of each particular group;
determining, by the computer, price discounts for each respective group of online shopping members based on the product purchasing affinity quotient corresponding to each particular group and other factors;
determining, by the computer, whether the price discounts increased product sales; and
responsive to the computer determining that the price discounts did increase product sales, updating, by the computer, product purchasing affinity quotients of the groups of online shopping members based on the product sales.

4. The computer-implemented method of claim 1 further comprising:
receiving, by the computer, an input to update product purchasing affinity quotients of members and groups of members;
retrieving, by the computer, records of the members;
calculating, by the computer, member product purchasing affinity quotients for each of the members based on characteristics of the members in the records;
calculating, by the computer, group product purchasing affinity quotients for each of the groups of members based on member product purchasing affinity quotients of each respective member in a particular group of members; and
updating, by the computer, a database with the member product purchasing affinity quotients and the group product purchasing affinity quotients.

5. The computer-implemented method of claim 1 further comprising:
determining, by the computer, whether an online shopping customer is identified as a member of a provider of a product of interest;
responsive to the computer determining that the online shopping customer is identified as a member of the provider of the product of interest, retrieving, by the computer, a record corresponding to the member;
calculating, by the computer, a new product purchasing affinity quotient corresponding to the member based on characteristics of the member recorded in the record; and
updating, by the computer, a member database with the new product purchasing affinity quotient of the member.

6. The computer-implemented method of claim 5 further comprising:
responsive to the computer determining that the online shopping customer is not identified as a member of the provider of the product of interest, generating, by the computer, a new member record for the online shopping customer in the member database;
identifying, by the computer, characteristics of the new member from information provided by the new member;
assigning, by the computer, an initial product purchasing affinity quotient to the new member based on identified characteristics of the new member; and
updating, by the computer, the member database to include the new member record and the initial product purchasing affinity quotient of the new member.

7. The computer-implemented method of claim 5 further comprising:
responsive to the computer determining that the online shopping customer is not identified as a member of the provider of the product of interest, generating, by the computer, a new member record for the online shopping customer in the member database;
determining, by the computer, whether the new member is identified as an existing member in one or more other provider member databases;
responsive to the computer determining that the new member is identified as an existing member in one or more other provider member databases, generating, by the computer, a product purchasing affinity quotient corresponding to the new member based on data in the one or more other provider member databases; and
updating, by the computer, the member database of the provider of the product of interest to include the new member record and the product purchasing affinity quotient of the new member.

8. The computer-implemented method of claim 1 further comprising:
receiving, by the computer, a selection of a product of interest from a client device corresponding to an online shopping customer;
enabling, by the computer, visualization of the product of interest by each respective member in a selected group of online shopping members at a same time;
enabling, by the computer, real time discussion of the product of interest between the online shopping customer and the selected group of online shopping members;
receiving, by the computer, an input to purchase the product of interest from the client device of the online shopping customer based on the real time discussion;
negotiating, by the computer, with a provider of the product of interest via a provider interface, a discounted price for the product of interest based on a product purchasing affinity quotient corresponding to the selected group of online shopping members;
determining, by the computer, whether the discounted price for the product of interest was accepted; and
responsive to the computer determining that the discounted price for the product of interest was accepted, completing, by the computer, a transaction to purchase the product of interest at the discounted price.

9. The computer-implemented method of claim 8 further comprising:
determining, by the computer, whether an input was received from the client device of the online shopping customer to retain the selected group of online shopping members;
responsive to the computer determining that an input was not received to retain the selected group of online shopping members, deleting, by the computer, the selected group of online shopping members; and
responsive to the computer determining that an input was received from the client device of the online shopping customer to retain the selected group of online shopping members, retaining, by the computer, the selected group of online shopping members.

10. The computer-implemented method of claim 1, wherein the product purchasing affinity quotient is a measure of product purchasing power and behavior of an online shopping member.

11. The computer-implemented method of claim 1, wherein the computer is implemented in one of an online product provider interface and an online shopping broker interface.

12. A computer system comprising:
a bus system;
a storage device connected to the bus system, wherein the storage device stores program instructions; and
a processor connected to the bus system, wherein the processor executes the program instructions to:
receive an input to generate a group of online shopping members based on product category of online shopping;
retrieve product purchasing affinity quotients of members in a member group corresponding to the product category of online shopping from a member group database;
select a set of members in the member group having a product purchasing affinity quotient above a defined affinity quotient threshold level corresponding to the product category of online shopping; and
generate the group of online shopping members based on the set of members in the member group having product purchasing affinity quotients above the defined affinity quotient threshold level corresponding to the product category of online shopping.

13. The computer system of claim 12, wherein the processor further executes the program instructions to:
display the group of online shopping members on a client device of an online shopping customer;
receive a selected group of members corresponding to the product category of online shopping from the client device of the online shopping customer based on selections in the displayed group of online shopping members;
calculate a product purchasing affinity quotient corresponding to the selected group of members based on product purchasing affinity quotients of respective members in the selected group of members; and
update the member group database with the product purchasing affinity quotient of the selected group of members.

14. The computer system of claim 12, wherein the processor further executes the program instructions to:
generate groups of online shopping members based on identifying similar member characteristics;
calculate a product purchasing affinity quotient for each respective group of online shopping members based on identified member characteristics of each particular group;
determine price discounts for each respective group of online shopping members based on the product purchasing affinity quotient corresponding to each particular group and other factors;
determine whether the price discounts increased product sales; and
update product purchasing affinity quotients of the groups of online shopping members based on the product sales in response to determining that the price discounts did increase product sales.

15. A computer program product comprising a computer readable storage medium having program instructions embodied therewith, the program instructions executable by a computer to cause the computer to perform a method comprising:
receiving, by the computer, an input to generate a group of online shopping members based on product category of online shopping;
retrieving, by the computer, product purchasing affinity quotients of members in a member group corresponding to the product category of online shopping from a member group database;
selecting, by the computer, a set of members in the member group having a product purchasing affinity quotient above a defined affinity quotient threshold level corresponding to the product category of online shopping; and
generating, by the computer, the group of online shopping members based on the set of members in the member group having product purchasing affinity quotients above the defined affinity quotient threshold level corresponding to the product category of online shopping.

16. The computer program product of claim 15 further comprising:
displaying, by the computer, the group of online shopping members on a client device of an online shopping customer;
receiving, by the computer, a selected group of members corresponding to the product category of online shopping from the client device of the online shopping customer based on selections in the displayed group of online shopping members;
calculating, by the computer, a product purchasing affinity quotient corresponding to the selected group of members based on product purchasing affinity quotients of respective members in the selected group of members; and
updating, by the computer, the member group database with the product purchasing affinity quotient of the selected group of members.

17. The computer program product of claim 15 further comprising:
generating, by the computer, groups of online shopping members based on identifying similar member characteristics;
calculating, by the computer, a product purchasing affinity quotient for each respective group of online shopping members based on identified member characteristics of each particular group;
determining, by the computer, price discounts for each respective group of online shopping members based on the product purchasing affinity quotient corresponding to each particular group and other factors;
determining, by the computer, whether the price discounts increased product sales; and
responsive to the computer determining that the price discounts did increase product sales, updating, by the computer, product purchasing affinity quotients of the groups of online shopping members based on the product sales.

18. The computer program product of claim 15 further comprising:
receiving, by the computer, an input to update product purchasing affinity quotients of members and groups of members;
retrieving, by the computer, records of the members;
calculating, by the computer, member product purchasing affinity quotients for each of the members based on characteristics of the members in the records;
calculating, by the computer, group product purchasing affinity quotients for each of the groups of members based on member product purchasing affinity quotients of each respective member in a particular group of members; and
updating, by the computer, a database with the member product purchasing affinity quotients and the group product purchasing affinity quotients.

19. The computer program product of claim 15 further comprising:
determining, by the computer, whether an online shopping customer is identified as a member of a provider of a product of interest;
responsive to the computer determining that the online shopping customer is identified as a member of the provider of the product of interest, retrieving, by the computer, a record corresponding to the member;
calculating, by the computer, a new product purchasing affinity quotient corresponding to the member based on characteristics of the member recorded in the record; and
updating, by the computer, a member database with the new product purchasing affinity quotient of the member.

20. The computer program product of claim 19 further comprising:
responsive to the computer determining that the online shopping customer is not identified as a member of the provider of the product of interest, generating, by the computer, a new member record for the online shopping customer in the member database;
identifying, by the computer, characteristics of the new member from information provided by the new member;
assigning, by the computer, an initial product purchasing affinity quotient to the new member based on identified characteristics of the new member; and
updating, by the computer, the member database to include the new member record and the initial product purchasing affinity quotient of the new member.
